(19) United States
(12) Patent Application Publication
(10) Pub. No.: US 2007/0142986 A1
(43) Pub. Date: Jun. 21, 2007

(54) System and method for recording information relating to a vehicle

(76) Inventor: Robert Alaous, Montreal (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/314,717

(22) Filed: Dec. 20, 2005

(51) Int. Cl. G06F 19/00

(52) U.S. Cl. 701/35; 340/438

(57) ABSTRACT

A system for recording information relating to a vehicle is described. The system includes a processor for controlling recording of the information; a sensor connected to the processor for obtaining sensed information relating to the vehicle; a motion detector connected to the processor for obtaining acceleration information relating to motion of the vehicle; and a memory connected to the processor for recording information, including the sensed information and the acceleration information. The processor controls starting the recording of the information to the memory on the basis of the acceleration information. A method of operating the system is also described.

### FIELD OF INVENTION

The present invention relates to a system and method for video information relating to a vehicle.

### BACKGROUND OF THE INVENTION

Vehicle information recording and maintenance systems are widely known as “black boxes”. Black boxes typically record information regarding the operation of a vehicle, and particularly information relating to incidents such as accidents.

The present application is directed to systems and methods relating to recording and maintaining vehicular information.

### SUMMARY OF THE INVENTION

In an aspect of the present invention, there is provided a system for recording information relating to a vehicle. The system comprises: a processor for controlling recording of the information; a sensor connected to the processor for obtaining sensed information relating to the vehicle; a motion detector connected to the processor for obtaining acceleration information relating to motion of the vehicle; and a memory connected to the processor for recording information, including the sensed information and the acceleration information. The processor controls starting the recording of the information to the memory in real time on the basis of the acceleration information.

The motion detector may be a three-axis accelerometer. The acceleration information obtained by the three-axis accelerometer may include longitudinal motion information, transverse motion information, and vertical motion information relating to the vehicle.

The analysis of the accelerometer information may include the processor determining if the acceleration information suggests a motion change in the vehicle from a stop position that is greater than a sensitivity level, and if so, initiating recording of the information.

The processor may further control stopping the recording of the information to the memory in real time on the basis of the acceleration information. The analysis of the acceleration information may also include the processor determining if the acceleration information suggests a motion change in the vehicle due to impact that is greater than the sensitivity level, and if so, terminating recording of the information for after a timed interval. The analysis of the acceleration information may further include determining that the acceleration information does not suggest a motion change that should trigger terminating recording of the information, if the vertical motion information as compared to the longitudinal and traverse information suggests a change in a road surface condition instead of impact.

The system may further comprise a plurality of input ports connected to the processor for receiving additional information relating to the vehicle.

The sensed information may visual information and the additional information may include on-board data (OBD)-II data. The OBD-II data may be used by the processor to control the recording of the information.

The memory may be non-volatile memory. The memory may be connected to the processor through a memory port, and the memory may be removable from the port.

The system may further comprise an auxiliary memory in a protected auxiliary casing. The auxiliary memory may be connected to the processor and the memory. The auxiliary memory may keep a copy of the information recorded by the memory. The protected auxiliary casing being may be removed a main casing housing the memory. The protected auxiliary casing may be heat and impact resistant, and may comprise a heat and impact resistant aluminium shell.

The sensor may be housed in a sensor casing removed from the main casing.

The sensor casing may include a heat element controlled by the processor, the heat element for adjusting the temperature of the sensor during low temperature use of the system. The sensor may be connected to the processor by a wireless connection. The wireless connection may be a Bluetooth connection.

The memory may be secured digital (SD) memory.

In another aspect of the invention, a method for recording information relating to a vehicle is provided. The method comprises: obtaining sensed information relating to the vehicle from a sensor connected to the vehicle; obtaining acceleration information relating to the motion of the vehicle from a motion detector connected to the vehicle; and recording the sensed information and acceleration information to a memory in real time, wherein the recording is controlled on the basis of the acceleration information.

The acceleration information may include longitudinal motion information, transverse motion information, and vertical motion information relating to the vehicle. The sensed information and the acceleration information may be wirelessly transmitted before being recorded in the memory.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes):

FIG. 1 depicts a vehicle information recorder system according to an embodiment of the present invention;

FIG. 2 depicts a sensor unit of the information recorder system of FIG. 1;

FIG. 3 depicts a block diagram of the vehicle information recorder system of FIG. 1;

FIG. 4 depicts a flow diagram of a software module operating with the recorder system of FIG. 1; and

FIG. 5 depicts a wireless sensor unit detachably attached to a user in another embodiment of a vehicular information recorder system.

### DETAILED DESCRIPTION OF AN EMBODIMENT

The description that follows, and the embodiments described therein, are provided by way of illustration of an example, or examples, of particular embodiments of the principles of the present invention. These examples are provided for the purposes of explanation, and not limitation, of those principles and of the invention. In the description, which follows, like parts are marked throughout the specification and the drawings with the same respective reference numerals.

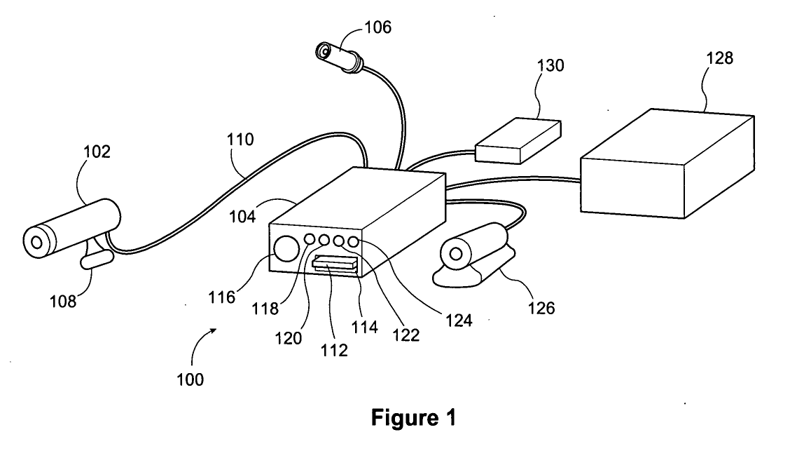

Referring to FIG. 1, there is shown an exemplary embodiment of vehicular information recorder system 100. System 100 includes sensor unit 102 for obtaining information, such as visual information, relating to a vehicle to which system 100 is connected to. Sensor unit 102 is connected to recorder unit 104 via data cable 110. Recorder unit 104 controls the operation of sensor unit 102 and receives information from unit 102 for processing and recording. System 100 is for connection and use with a vehicle, such as an automobile, motorcycle or snowmobile. In operation, sensor unit 102 obtains information relating to the vehicle and provides the information to recorder unit 104 to process and record the information to a data storage.

System 100 may be connected to a vehicle by attaching sensor unit 102 to, for the example of an automobile, a dashboard of the automobile by connector 108 and having recorder unit 104 placed inside the glove-box of the automobile, or otherwise placed on or secured to the center console or dashboard of the automobile. For use in other vehicles, such as a motorcycle, sensor unit 102 may be attached at the handle-bars of the motorcycle, while the recorder unit 104 may be secured to a storage area of the motorcycle. Since sensor unit 102 obtains visual information, sensor unit 102 should be secured to the vehicle in such a way as to provide a line of sight towards an orientation to which visual information is to be recorded.

Having sensor unit 102 separated from recorder unit 104 tends to offer greater protection to the processing and memory circuits of system 100, since for sensor unit 102 to be placed so as to obtain good visual information, it is typically placed in a less protected area of a vehicle, such as for example behind a windshield of an automobile. If recorder unit 104 was not separated from sensor unit 102, such placement at a less protected area of a vehicle would tend to increase the likelihood of the processing and memory circuits of recorder unit 104 being damaged in case of an accident involving the vehicle. However, for the embodiment the ability to have place recorder unit 104 removed from sensor unit 102 tends to permit recorder unit 104 to be placed in a more protected area of a vehicle.

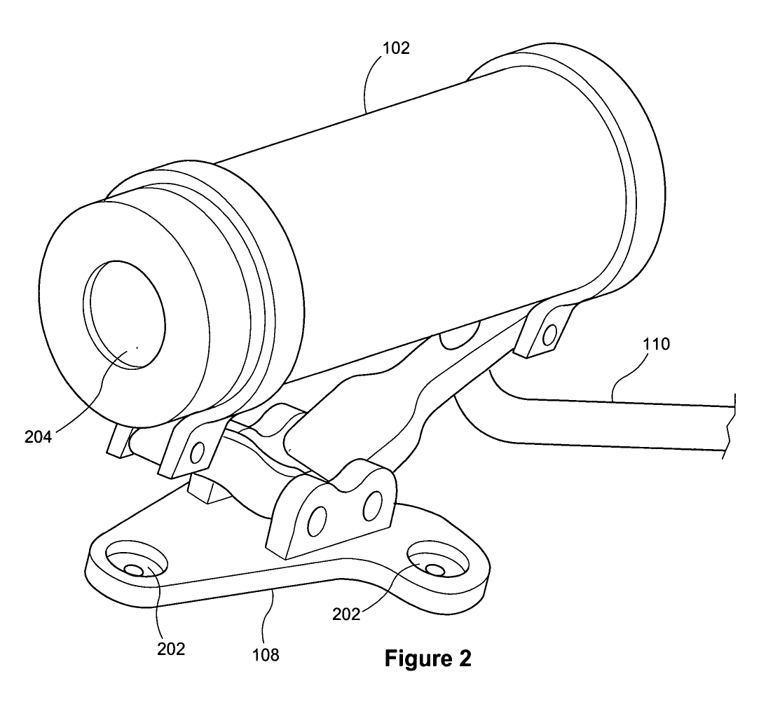

Referring to FIG. 2, additional details regarding sensor unit 102 is shown. Sensor unit 102 is attached to connector 108 that provides attachment to a vehicle. For the embodiment, connector 108 provides screw-holes 202 for screws (not shown) to be secured therethrough for attaching connector 108 to the vehicle. In other embodiment, other attachments, such as an adhesive, may be used.

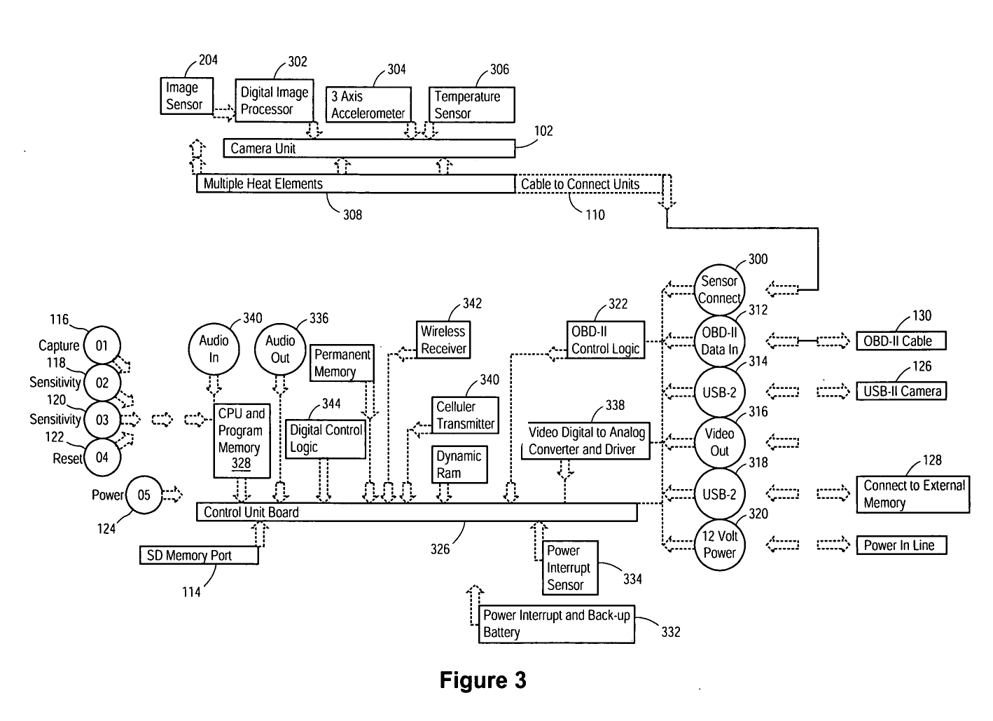

Referring now to FIG. 3, block diagram of components of system 100, including sensor unit 102, are shown. For the embodiment, sensor unit 102 includes image sensor 204 for obtaining visual information, and sensor unit 102 is typically mounted to a vehicle such that image sensor faces forward along the longitudinal direction of the vehicle. For the embodiment, image sensor 204 is a colour CMOS VGA image sensor having two-piece liquid crystal lens, such as available from ST Microelectronics™. Image sensor 204 is connected to digital image processor (DSP) 302 to digitize the visual information obtained from image sensor 204 into digital signals for transfer to recorder unit 104 through data cable 110. DSP 302 may include color processing and exposure control functions on the visual image information. In other embodiments, the visual image may be transferred with other signals, such as non-digital signals.

Sensor unit 102 includes motion detector 304. For the embodiment, motion detector 304 is a 3-axis accelerometer that observes motion along three orthogonal axes, for example, in the longitudinal, transverse, and vertical axes relative to the vehicle. Acceleration information observed from motion detector 304 is also provided to recorder unit 104 through data cable 110. It will be appreciated that in other embodiments, motion detector 304 may be housed separately from imaged sensor 302, and it may observe motion along other axes.

Sensor unit 102 further optionally includes temperature sensor 306 and heat elements 208. Temperature sensor 306 observes the temperature of sensor unit 102 and provides temperature information to recorder unit 104 through data cable 110. Should the detected temperature be low enough to affect operation of sensor unit 102, recorder unit 104 may send control signals through data cable 110 to image sensor 102 to turn on heat elements 308 for a period of time so that the temperature of sensor unit 102 may be kept within an operating range.

Referring still to FIG. 3, recorder unit 104 includes connection ports 310 to 320 for receiving different connections to unit 104, including sensor unit connect port 310 for connection to data cable 110 for receiving information from sensor unit 102. For the embodiment, data cable 110 is a 5-pair cable with a T1000 network plug, which is selected to provide reliable data transfer over a cable distance of 6 feet between sensor unit 102 and recorder unit 104. It will be appreciated that other cables and connectors may be selected in other embodiments by one of skill in this art, having regard to the strength of signals to be transferred and the length of cable for the desired application. As described in greater detail below, in other embodiments, a wireless connection may be provided between sensor unit 102 and recorder unit 104.

Unit 104 also includes power port 320 for connecting to power adapter 106 (shown in FIG. 1). For the exemplary embodiment used with an automobile, power adapter 106 is connectable to a 12-volt cigarette lighter socket typically found in the interior of the automobile to provide power to the recorder unit 104. Back-up power is provided by battery circuit 332 for operation of recorder unit 104 when power is not supplied through power adapter 106, such as when the automobile has been in an accident and the car battery is cut off from the cigarette lighter socket. For the embodiment, battery circuit 332 includes a 9-volt battery. Battery circuit 332 further provides interrupt-power when the power supplied to recorder unit 104 is interrupted, such as when the automobile is jostled as it moves over an uneven surface and a power connection is momentarily broken. It will be appreciated that for use in providing interrupt power, in other embodiments one or more capacitors may be used. Battery circuit 332 is connected to control board 326 of recorder unit 104. Battery circuit 332 may be connected to power interrupt sensor 334, which is circuitry that detects when there is an interrupt to the power supplied from power port 320 and enables battery power to be provided by battery circuit 332 to control board 326.

Control board 326 is a PCB board on which buses and circuit connections are made available for connection to the various components of recorder unit 104, as described above and below. For the embodiment, unit 104 include other ports, such as: on-board diagnostics (OBD) II compliant port 312 for connection to an automobile's diagnostic data; one or more USB-2 compliant ports 314, 318 for connection to other optional USB devices; and a video-out port 316 for allowing direct playback of data stored in unit 104 to a video display. For the embodiment, video-out port 316 comprises a RCA compatible connection for output of video signals to any display with a RCA-in connection. Ports 310 to 320 are connected to control board 326 of recorder unit 104. An audio output device 336, such as a sound speaker, may optionally be connected to control board 326 of recorder unit recorder 336 for providing audio feedback to a user as to the status of system 100.

OBD-II compliant port 312 receives data regarding an automobile to which system 100 is connected via an OBD-II cable 130. OBD-II is a set of standards for systems and signals used in the electronic control and diagnosis of automobiles created by the Society of Automotive Engineers (SAE), which were adopted by the United States Environmental Protection Agency and California Air Resources Board for implementation in 1996. A large number of cars and light trucks today, including all cars built since Jan. 1, 1996, have OBD-II systems. OBD-II systems monitors the electronics control of automobiles, and provides diagnosis of engine, chassis, and other functions and features of automobiles. An OBD-II systems of an automobile provides a continual set of information relating to the automobile that may be examined by connecting to the OBD-II cable 130 supplied with the OBD-II system of the automobile. For the embodiment, OBD-II cable 130 is connected to OBD-II compliant port 312, which is in turn connected to OBD-II control logic 322 in recorder unit 104. OBD-II control logic 322 provides decoding of information received from an automobile's OBD-II system and provides the decoded information through control unit board 326 to main processor 328 for analysis. It will be appreciated that the decoding of OBD-II information may be done by other components in other embodiments.

Data from sensor unit 102 received through sensor unit connect port 310 is also provided through control unit board 326 to main processor 328. Main processor 328 provides the main controls for the functioning of system 100. For the embodiment, an IMX-21 processor made by Motorola, Inc.™ is used, but it will be appreciated that other processors may be used in other embodiments. In the embodiment, as data, including visual information, from sensor unit 102 and an OBD-II system of an automobile, is received at recorder unit 104, processor 328 analysis the data and directs storage of the data to a removable memory device connected to memory port 114. For the embodiment, a secured-digital (SD) flash memory card 112 (shown in FIG. 1) is connected to memory port 114 for storing the data. Selected information received from OBD-II compliant port 312 is added to the digitized video data received from sensor unit 102, and stored as MPEG4 video information to the SD card. For the embodiment, the selected OBD-II data (such as relating to vehicle speed, engine speed, throttle application, brake application, and air-bag deployment) are inserted by processor 328 as visual information to the bottom of visual images received from sensor unit 102. The recorded visual information therefore includes both the visual images received from sensor unit 102 and selected OBD-II from an automobile's OBD-II system. For use in a vehicle without OBD-II data, only information from sensor unit 102 will be stored in the recorded visual information. It will be appreciated that other data formats and storage devices or methods may be used in other embodiments.

The recorded visual information, as processed by processor 328, is provided through control board 326 to memory card 112 in memory port 114 for recording and storage as digitized video in MPEG-4 format. In other embodiments, other memory and storage arrangements may be used. Processor 328 utilizes the storage memory in memory card 112 in a continuous loop. As such, the recorded visual information stored in memory card 112 tends to represent data from a period of time right before recorder unit 104 stops recording information, since in the continuous loop memory usage scheme the oldest data in memory card 112 is overwritten with new information as the maximum storage capacity of memory card 112 is reached. Depending on the size of memory card 112 and a selectable visual image quality for recording the recorded visual information, memory card 112 may store different information relating to different lengths of time prior to recording being stopped. Processor 328 may also be programmed to automatically adjust the image quality to always provide a fixed period of recording regardless of the storage capacity of memory card 112, in addition to a user-definable period of time after an incident occurs. For the exemplary embodiment, processor 328 and memory 112 is configured by default to provide 25 minutes of continuous recorded visual information, which includes 5 minutes of recording after the occurrence of an incident, as described in greater detail below. It will be appreciated that for the embodiment, the recording of information to memory card 112 is in real time. This tends to be more advantageous than systems in which data is first recorded to volatile memory, and then later written to non-volatile memory for storage. If an incident occurs during which system 100 is damaged, data will not be lost because it was not placed into storage memory in real time, as may occur in non-real time recording systems.

Processor 328 is provided with one or more software modules that are loadable into program-use memory provided with processor 328 for execution on processor 328. For the embodiment, the software modules causes processor 328 to operate system 100 as described herein. Processor 328 is configured to boot from a SD memory card 112 in port 114 first, and only if a bootable program is not found on card 112, will processor 328 boot from its program-use memory. In this way, the embodiment permits software modules to be loaded into program-use memory associated with processor 328 via an upload from a SD memory card 112 inserted into memory port 114 at power-on of system 100.

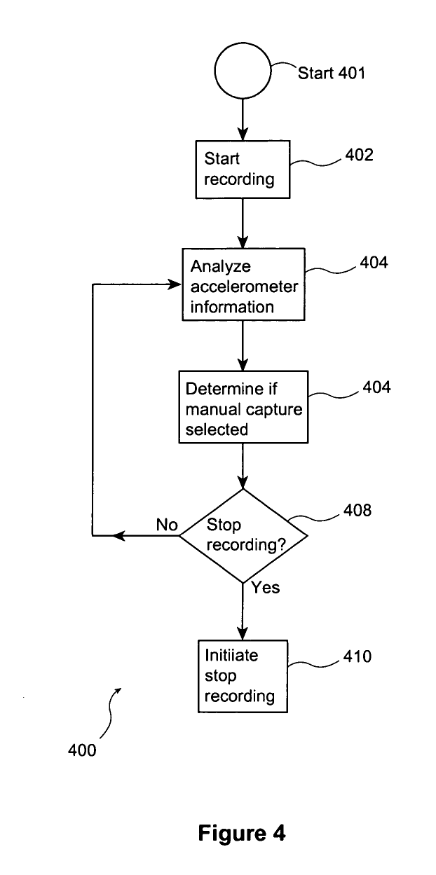

For the embodiment, the software modules provide the control for the operation of system 100 include a software module 400 that is graphically depicted as a block-diagram flowchart in FIG. 4. Therein, software module 400 initializes and begins operation at step 401, which step is started with the depression of power button 124 (shown in FIGS. 1 and 3), which is connected to processor 328 to turn on system 100. Once system 100 is initialized, at step 401 module 400 determines if recording should begin. In step 401, a stop capture flag is examined to evaluate if the flag is set. As described in greater detail below, this flag provide an indication of whether the data currently stored on memory card 112 is flagged for storage and not to be overwritten. If the flag is set, then system 100 remains powered on but does not proceed to step 402 to begin recording information. An audio signal may then be optionally sent to audio output device 336. If the stop capture flag is not set, however, then step 402 is taken and the accelerometer information received from accelerometer 304 is analyzed to determine if the vehicle to which system 100 is connected is in motion, such as by determining if there is motion along the longitudinal or transverse axes. If so, then recording begins and module 400 proceeds to step 404. Otherwise, step 402 waits for motion to be detected before beginning recording and proceeding to step 404. If at step 402 no motion is detected after a time-out period, then module 400 powers down system 100.

At step 404, information from accelerometer 304 is analyzed again to determine if an incident has occurred, and at step 406, it is determined whether manual capture push-button 116 (shown in FIGS. 1 and 3) has been depressed. At step 408, a determination is made as to whether the recording of data is to be terminated, based on whether an incident has been determined to have occurred or if manual capture button 116 has been depressed. If neither are true, then module 400 continues recording and returns to step 402. If either an incident is deemed to have occurred, or if manual capture button 116 has been depressed, then step 410 is taken to initiate termination of recording of information.

Further details on steps 404, 406, 408 and 410 are now provided. In step 404, acceleration, or accelerometer, information from motion detector 304 is analyzed to determine if an incident has occurred. An incident may be an accident in which sudden impact is observed through accelerometer 304. For the embodiment, motion detector 304 is a 3-axis accelerometer that provides a third axis along a vertical orientation relative to the vehicle to which system 100 is connected, which tends to assist in filtering out “false” incidents that might otherwise be determined with observation merely along the longitudinal and transverse axes. For example, during impact most often associated with an accident, the motion observed by 3-axis accelerometer typically tend to be along the longitudinal and transverse axes, with a relatively minor component along the vertical axis. However, during vehicle operation and typically due to an uneven surface over which the vehicle is traversing, there may be impacts experienced along the longitudinal or transverse axes that are greater than the sensitivity of system 100 that is set by the system or a user (described below), but which are not true incidents since the vehicle may simply be travelling, for example, over a pot-hole. In these circumstances, although the impact registered along the longitudinal and transverse axes are significant, they tend to be relatively minor compared to impact registered along the third, vertical axis. As such, step 404 of module 400 may be utilized to filter out impacts experienced by the vehicle that are not indicative of an incident that leads to a termination of the recording of information, such as when the vehicle is traversing a pot-hole but is not involved in an accident. As described in greater detail below, once an incident is determined to have occurred, recording of information will be scheduled to stop in step 410. Optionally, step 404 may trigger an audio notification to be issued from audio output 336, such as a beep or a series of sounds, to notify a user of system 100 that an incident has been detected and that recording will be scheduled for termination.

For the embodiment, an incident may also includes a situation in which the acceleration information received from motion detector 304 indicates that the vehicle to which system 100 is connected has been stationary for a period of time. This tends to indicate that the vehicle has been parked but a user may have forgotten to power down system 100 by pressing button 124. Module 400 may be programmed such that if no motion was detected for a period of time, then an incident is deemed to have occurred such that recording of information is to be terminated, as described below with respect to steps 408 and 410.

In step 406, module 400 determines if manual capture button 116 has been depressed. For example, should a user of system 100 decide to save the information just recorded by system 100, or to obtain and save information that is about to happen, the user may depress capture button 116. As described above, for the embodiment there is by default a 25-minute recording period. As described in greater detail below with respect to steps 408 and 410, once capture button 116 is depressed, system 100 will be scheduled to stop recording after a preset period of time, so that the over-writing of oldest data is terminated and system 100 provides a recording of information for the period of time before recording was stopped. For the embodiment, system 100 continues to record information in the normal course for 5 additional minutes after button 116 is pressed before terminating recording (and the overwriting of older recorded data) so that information relating to the 20 minutes prior to the button 116 being pressed, and information relating to the 5-minute period after button 116 is pressed, is recorded onto memory card 112. As with the detection of an incident, once button 116 is depressed, step 406 may optionally cause a sound to be emitted from sound output device 336. It will be appreciated that other recording time schemes may be employed in other embodiments.

In step 408, module 400 examines if either an incident was deemed to have occurred at step 404, or if the manual capture button 116 was determined to have been depressed at step 406. If neither has occurred, then module 400 returns to step 402. If either has occurred, then step 41 0 is taken to schedule termination of recording of information by system 100.

In step 410, module 400 analyzes which of whether an incident has occurred or if the manual capture button 116 was depressed. If an incident was deemed to have occurred, then it is determined whether the incident is one for which no motion of the vehicle was detected by motion detector 304 for a period of time, as described above. If so, then step 410 may terminate recording of information immediately, and power down system 100. Thereafter, system 100 and module 400 may be re-started to continue recording information by pressing the power button 124 of recorder unit 104, as described above. Optionally, step 410 may make no distinction between different incidents and schedule system shut down and powering off according to a single scheme of delay, as described below. It will be appreciated that different power-off schemes may be employed for different incidents in other embodiments.

Considering step 410 for the embodiment, if it is determined that the capture button was depressed, or that an incident that is not “no motion” was detected by motion detector 304, then module 400 schedules stopping recording of information after a period of time. For the embodiment, this period of time is five minutes. After this period of time has elapsed, then step 410 stops recording of the information, sets a stop capture flag, and powers down system 100. It will be appreciated that for the embodiment, the recording of information to memory card 112 is in real time.

The stop capture flag is a Boolean variable indicating that recording has stopped due to a non-time-out incident occurring or that the capture button 116 was pressed. As described above, when this flag is set, module 400 does not continue recording information that might overwrite information stored on memory card 112 until reset button 122 is depressed, which clears the stop capture flag. With reset button 122, when a user of system 100 wishes to continue recording on a memory card 112, such as after the data on card 112 has been reviewed, copied elsewhere for archival, or if card 112 is replaced with another card, then reset button 122 may be pressed to re-start system 100 to record information again.

Software module 400 may operate with other modules to provide for sensitivity and image quality adjustments to be made manually or automatically. For example, in the embodiment sensitivity buttons 118 and 120 are provided to adjust the level of motion detected by accelerometer 304 that would deem an incident as having occurred, with button 118 decreasing the sensitivity and button 120 increasing the sensitivity of system 100. Additionally, module 400 and other modules provide other controls, such as for observing information received from temperature sensor 306 and providing control signals to turn on and off heat elements 308 in sensor unit 102. It will be appreciated that processor 328 is programmed to perform and control the functions described herein by use of software module 400 and other software modules and routines. Since the description of these controls and functions, and of module 400 above is sufficient to enable a person of skill in this art to program processor 328, the exact programming techniques that may be employed are not described in further detail. It will also be appreciated that the functions of module 400 and other software modules may be implemented on hardware circuits, or a combination of hardware and software, in other embodiments.

Referring again to FIGS. 1 and 3, for the embodiment optional attachments may be connected to system 100 through the ports connected to control board 326 of recorder unit 104. For example, a USB camera 126 may be connected to USB port 314 to provide in conjunction with sensor unit 102 visual information in two directions, such as forward and rearward depending on the placemen of sensor unit 102 and camera 126 with respect to a vehicle to which system 100 is connected. In other embodiments, still more sensor units 102 and USB cameras 126 may be connected to system 100 to record information from other directions. An external memory unit 128 may also be connected to USB port 318 to keep a second copy of the data recorded in memory card 112. For the embodiment, external memory unit 128 is configured so that data is written to it at the same time as it is written to memory card 112, so that memory unit 128 has an exact copy of the data on card 112 at all times. External memory unit 128 may have a casing and memory circuits that are thermo-shielded and impact resistant, so as to protect the data recorded therein from damage in case of an incident involving high physical stress or temperatures. In an embodiment, the casing of external memory unit 128 may comprise bullet-resistant machined aluminium, heat resistant polymers and asbestos lining. It will be appreciated that in other embodiments additional ports, USB or otherwise, may be provided to connect to other peripherals.

For the embodiment, recorder unit 104 further includes a digital to analog video converter 338 for outputting the recorded visual information on memory card 112 or external memory unit 128 through video out port 316. Unit 104 may further comprise a wireless transceiver 342 to provide wireless connectivity between recorder unit 104 and other peripherals, such as one or more wireless camera units that provide information to recorder unit 104 for recording to memory. For the embodiment, wireless connectivity includes Bluetooth connectivity, and on-board digital control logic for Bluetooth wireless connectivity is provide by control logic 344. Optionally, cellular transmitter 340 may also be provided with recorder unit 104 for additionally information to be received or transmitted, including for example automatic calls to be made to an emergency number when a high-impact incident is detected. Additionally, global positioning system (GPS) data may also be received from a GPS system (not shown) connected to system 100 for recording on memory card 112 and external memory unit 128 in the same manner that OBD-II data is recorded, as described above.

Still additionally, an audio input device 340 may be provided with recorder unit 104. Audio signals may also be continually recorded as digitized signals onto memory card 112 and external memory unit 128, or be recorded only for a period of time upon detection of particular sound signals, such as sirens of emergency vehicles. Optionally, system 100 may be configured to terminate recording of information after a period of time, as described above, in response to such audio signals.

It will be appreciated that in another embodiment, the physical arrangements of the components of system 100 may be separated onto multiple units that are connected together by wire or wirelessly.

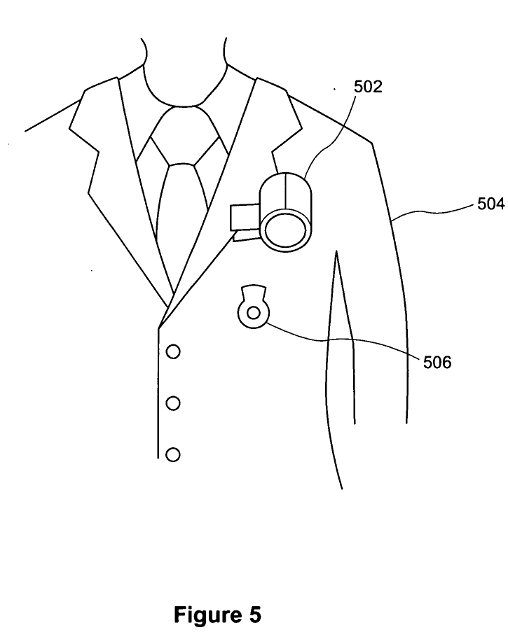

Referring to FIG. 5, an alternate embodiment is shown in which sensor unit 502 is provided with user 504. Sensor unit 502 is similar to sensor unit 102 described above with respect to FIGS. 1 to 3, with the exception that it has its own internal power source and has wireless connectivity, such as Bluetooth, to a recorder unit associated with sensor unit 502. As shown, sensor unit 502 may be detachably attached to a user 504, such as for example by a clip, or a hook and loop attachment, for recording visual information generally seen by user 504. Depending on the application, sensor unit 502 may not have an accelerometer associated therewith, but may have a button operating in the same way as stop capture button 116 described above that wirelessly controls stopping of information recording. One exemplary application for sensor unit 502 and its associated recorder unit would be for a user 504 who is a police officer. In such an application, sensor unit 502 may be wirelessly connected to its associated recorder unit aboard the police officer's vehicle, so as to provide a visual record of information witnessed by the police office even when the police office is away from the police vehicle. In such an application, sensor unit 502 may also be adapted to be attached to a badge 506 of the police officer.

It will be appreciated from the above examples that a myriad of components and methods may be used to implement embodiments of the invention.

Although the invention has been described with reference to certain specific embodiments, various modifications thereof will be apparent to those skilled in the art without departing from the spirit and scope of the invention as outlined in the claims appended hereto.

I claim:

1. A system for recording information relating to a vehicle, comprising:
a processor for controlling recording of the information;
a sensor connected to the processor for obtaining sensed information relating to the vehicle;
a motion detector connected to the processor for obtaining acceleration information relating to motion of the vehicle; and
a memory connected to the processor for recording information, including the sensed information and the acceleration information,
wherein the processor controls starting the recording of the information to the memory in real time on the basis of the acceleration information.

2. The system of claim 1, wherein the motion detector is a three-axis accelerometer, and the acceleration information obtained by the three-axis accelerometer include longitudinal motion information, transverse motion information, and vertical motion information relating to the vehicle.

3. The system of claim 2, wherein the analysis of the accelerometer information includes:
the processor determining if the acceleration information suggests a motion change in the vehicle from a stop position that is greater than a sensitivity level, and if so, initiating recording of the information.

4. The system of claim 3, wherein the processor further controls stopping the recording of the information to the memory in real time on the basis of the acceleration information, and the analysis of the acceleration information includes:
the processor determining if the acceleration information suggests a motion change in the vehicle due to impact that is greater than the sensitivity level, and if so, terminating recording of the information for after a timed interval.

5. The system of claim 4, wherein the analysis of the acceleration information includes determining that the acceleration information does not suggest a motion change that should trigger terminating recording of the information, if the vertical motion information as compared to the longitudinal and traverse information suggests a change in a road surface condition instead of impact.

6. The system of claim 5, further comprising a plurality of input ports connected to the processor for receiving additional information relating to the vehicle.

7. The system of claim 6, wherein the sensed information is visual information and additional information include on-board data (OBD)-II data, and the information recorded to the memory include the OBD-II data.

8. The system of claim 7, wherein the memory is non-volatile memory.

9. The system of claim 8, wherein:
the memory is connected to the processor through a memory port; and
the memory is removable from the port.

10. The system of claim 9, further comprising an auxiliary memory in a protected auxiliary casing, the auxiliary memory connected to the processor and the memory, the auxiliary memory keeping a copy of the information recorded by the memory, and the protected auxiliary casing being removed a main casing housing the memory.

11. The system of claim 10, wherein the protected auxiliary casing is heat and impact resistant.

12. The system of claim 11, wherein the protected auxiliary casing comprise a heat and impact resistant aluminium shell.

13. The system of claim 12, wherein the sensor is housed in a sensor casing removed from the main casing.

14. The system of claim 13, wherein the sensor casing includes a heat element controlled by the processor, the heat element for adjusting the temperature of the sensor during low temperature use of the system.

15. The system of claim 14, wherein the memory is secured digital (SD) memory.

16. The system of claim 15, wherein the sensor is connected to the processor by a wireless connection.

17. The system of claim 16, wherein the wireless connection is a Bluetooth connection.

18. A method for recording information relating to a vehicle, comprising:
obtaining sensed information relating to the vehicle from a sensor connected to the vehicle;
obtaining acceleration information relating to the motion of the vehicle from a motion detector connected to the vehicle; and
recording the sensed information and acceleration information to a memory in real time, wherein the recording is controlled on the basis of the acceleration information.

19. The method of claims 18, wherein the acceleration information include longitudinal motion information, transverse motion information, and vertical motion information relating to the vehicle.

20. The method of claim 19, wherein the sensed information and the acceleration information are wirelessly transmitted before being recorded in the memory.
